(19) United States
(12) Patent Application Publication
(10) Pub. No.: US 2026/0228210 A1
(43) Pub. Date: Aug. 6, 2026

(54) FUNCTION PUBLICATION METHOD

(71) Applicant: FNV IP B.V., Leidschendam (NL)

(72) Inventor: Jorg DONAT, Leidschendam (NL)

(73) Assignee: FNV IP B.V., Leidschendam (NL)

(21) Appl. No.: 19/153,294

(22) PCT Filed: Feb. 12, 2024
(86) PCT No.: PCT/EP2024/053414

§ 371 Date: Aug. 1, 2025

(30) Foreign Application Priority Data
Feb. 13, 2023 (NL) 2034137

(51) Int. Cl. G06F 16/242; G06F 16/28

(52) U.S. Cl. CPC G06F 16/2445; G06F 16/284

(57) ABSTRACT

According to a first aspect of the present disclosure, there is provided a computer-implemented method of retrieving data from a database system. The method comprises: receiving, a selection of a location within a database system, wherein the database system comprises one or more databases, wherein data at the identified location within the database system is of a first data format; displaying, a list of one or more publication methods; receiving, a selection of a publication method from the list of one or more publication methods, wherein the selected publication method corresponds to the selected location of the database system; and executing, the selected publication method to interrogate the identified location of the database system, wherein executing the identified publication method produces a data output, wherein the data output comprises data in a second data format different to the first data format. Unlocking insights from Geo-Data, the present invention further relates to improvements in sustainability and environmental developments: together we create a safe and liveable world.

### TECHNICAL FIELD

The disclosure relates to methods and systems for retrieving information from a database. More specifically, geodata is retrieved from a database system and the format of the data is altered to produce a data output in a different format, in order to make the data output compatible with other systems. Unlocking insights from Geo-Data, the present invention further relates to improvements in sustainability and environmental developments: together we create a safe and liveable world.

### BACKGROUND

There is a general and ongoing need for systems and methods for determining sub-surface ground parameters. In particular, there is a need for systems and methods that can be used to model the properties of a target volume beneath the surface of the earth to provide information useful for infrastructure planning. There is also a need to determine sub-surface soil composition and structure. Determination of sub-surface ground properties in this manner during the early planning phase of construction projects reduces uncertainty during the location determination, foundation design, and construction phases of a project. This in turn reduces delays, overspend, and unnecessary use of material resources (e.g. concrete) during construction.

A variety of techniques can be used to ascertain the properties of a target sub-surface volume. These include down-hole and cross-hole techniques whereby one or more boreholes are drilled and soil samples obtained from the borehole are analysed. Other geological entities such as ground water wells can also be studied. Geological data (referred to herein as geodata) can also be obtained through seismology, from climate measurement stations and through a variety of other similar geological entities and investigations. Such geological study typically yields a large amount of geodata from a variety of sensors and data sources. Processing, storing and outputting such a large amount of geodata in a way that is computationally efficient, conforms with often complex and varying standards for representation of geodata, and is intuitively understandable to an analyst is problematic, due to the volume of data and the fact that data often comes from many different locations and data sources.

There is a need to provide improved mechanisms for processing, sorting, standardising and outputting such geodata in a manner that is computationally efficient, conforms with standards for representation of geodata, and facilitates easy and intuitive understanding of data and comparison between data arising from different geological entities and data sources. As such, there is a need for changing the format or structure of data stored in a geodatabase system to make it readable and usable by a desired software. This can be done by exporting data from a database system in the same structure as stored in the database system and then performing postprocessing on the exported data in order to convert the data into a second desired data structure. However, such post processing is time intensive and may introduce errors in the data.

A more accurate method of altering the data structure of data stored in relational database systems, can be performed using a programming language, for example, structured query language (SQL) in order to communicate with the data stored in the database system. SQL can be used to change the data structure prior to export into a desired data format. However, this method requires a user to have programming knowledge, making the method accessible to only a fraction of database users. Furthermore, database systems may comprise multiple databases with different database specific syntax. For example, common database types include: Microsoft Access, Microsoft SQL-Server, Oracle Server, PostgreSQL, MySQL Server, SQLite, Firebird. Users wishing to retrieve data from a database system comprising databases of one or more of these database types would have to know database-specific syntax for each of the databases and be able to identify when to use which syntax. Therefore, there is a requirement for time efficient systems and methods for altering the format of geodata without being requiring expertise in computing.

### SUMMARY

According to a first aspect of the present disclosure, there is provided a computer-implemented method of retrieving data from a database system. The database system may comprise one or more relational databases. The data may be geodata. “Geodata” in this context means geological data, in other words any form of data obtained through geological study pertaining to one or more properties of a sub-surface volume, particularly ground (e.g. soil, rock, water) characteristics. Geological data can be used in contexts such as borehole logs, well design, data sequence graphs and so on. The method comprises: receiving, a selection of a location within a database system, wherein the database system comprises one or more databases, wherein data at the identified location within the database system is of a first data format; displaying, a list of one or more publication methods; receiving, a selection of a publication method from the list of one or more publication methods, wherein the selected publication method corresponds to the selected location of the database system; and executing, the selected publication method to interrogate the identified location of the database system, wherein executing the identified publication method produces a data output, wherein the data output comprises data in a second data format different to the first data format. In the present disclosure, interrogating a database system should be understood as any action of viewing, reading, altering, writing to or exporting from a database system. This enables a user to select a location within a database system and obtain data from the selected location in a desired format (for example, a format useable by a different application), wherein the format is determined by the publication method. As a result, a user can obtain data in a format compatible with other systems without having to use programming to manipulate data.

The selected publication method may comprise: a level requirement defining the one or more locations within the database system at which the publication method can be executed; a plurality of publication steps, wherein each publication step of the plurality of publication steps corresponds to an action performed on the database system or an action performed on the data in the database system, wherein executing the publication method comprises executing the one or more of the publication steps in a pre-defined order; and optionally a description indicating the outcome of the actions performed by the publication steps. The level requirement prevents publications being executed that will error due to incorrect syntax or query terms. The publication steps define each action performed in a step-by-step breakdown, the description indicates the outcome of running the publication method to increase useability.

A publication step of the plurality of publication steps may be any one of: an export action; an export ground description action; an unpack data sequences action; an action performed by one or more SQL commands; and a close database connection action, wherein executing the publication method comprises performing the plurality of publication steps in a pre-defined order. This assists a user without programming knowledge in easily managing and selecting a publication method as the method is broken down into small steps. The publication method may be edited by adding or removing publication steps. For example, in some aspects, the output file format of the publication method can be edited by replacing an existing publication step corresponding to an export action with a new publication step corresponding to an export action. In some aspects, only publication methods comprising a level requirement compatible with the received selection of a location are displayed, put differently, in some aspects publication methods that cannot be executed at a given location are not listed.

In some aspects, at least one of the plurality of publication steps corresponds to an action performed by one or more SQL commands, wherein executing the publication method comprises executing the one or more SQL commands in a pre-defined order to perform the corresponding action. This enables a user to use SQL to retrieve data from a database without requiring that the user has a knowledge of SQL. In such aspects, the at least one publication step may further comprise a label specifying the one or more SQL commands are of a generic syntax or of a database specific syntax. In aspects where a publication step comprises a label specifying the one or more SQL commands are of a database specific syntax, on execution, the action may be performed by one or more SQL commands of a database-specific syntax that can only be executed on a first specific database type, and wherein the at least one publication step further comprises a label specifying the one or more SQL commands are of a first database-specific syntax. Alternatively, on execution the action may be performed by one or more further SQL commands of a database-specific syntax that can only be executed on a second specific database type, wherein the publication step further comprises a label specifying the one or more further SQL commands are of a second database-specific syntax different from the first database-specific syntax. In such aspects, the database specific syntax may be determined based on the location selection. This enables the appropriate SQL command to be run for a given action based on the database type.

In some aspects, an SQL command may comprise a macro. A macro is generally understood as a single instruction that expands automatically into a set of instructions to perform a particular task. This increases the useability of a given publication step as the macro may pull a table or object name from the specified location without requiring hard coding. As a result, publication methods using publication step comprising a macro can be executed in more than one location.

In some aspects, at least one of the plurality of publication steps corresponds to an export action to export the output data to a pre-defined file format, optionally, wherein the pre-defined file format comprises one of a MS Access database export file, a *.ales file, *.txt file or a *.csv file. This enables a user to select a file type of the output of the publication method without having to have any knowledge of computer programming.

According to another aspect of the present disclosure, there is provided a system comprising one or more processors and one or more memories having stored thereon computer-readable instructions configured to cause the one or more processors to perform any of the methods disclosed herein.

According to another aspect of the present disclosure, there is provided a computer-readable medium comprising instructions, that, when executed by one or more data processing apparatus, cause the one or more data processing apparatus to perform any of the methods disclosed herein.

According to another aspect of the present disclosure, there is provided a computer program comprising instructions which, when the program is executed by a computer, cause the computer to perform any of the methods disclosed herein.

### BRIEF DESCRIPTION OF DRAWING

Disclosed implementations will now be described by way of example to illustrate aspects of the disclosure and with reference to the accompanying drawings, in which:

FIG. 1 shows schematically a system 100 that can be used to implement the disclosed methods;

FIG. 2 shows a subset of system 100;

FIG. 3 shows a subset of publication steps of system 100;

FIG. 4 shows a SQL command defining a publication step of system 100;

FIG. 5 shows a method 500 of retrieving data from a database system;

FIG. 6 shows a method 600 of executing a SQL publication step of the selected publication method;

FIG. 7 shows a method 700 of creating a publication method; and

FIG. 8 shows a block diagram of one implementation of a computing device 800.

### DETAILED DESCRIPTION

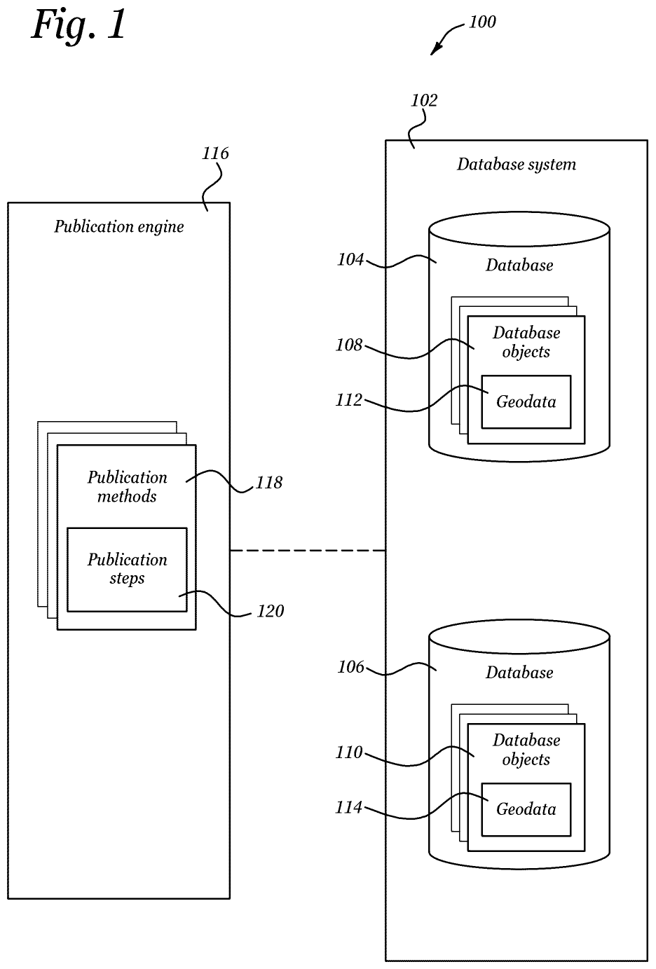

FIG. 1 shows a system 100 that can be used to implement the disclosed methods. The depicted database system 102 comprises one or more databases 104, 106. The one or more databases may be relational databases which are structured to recognize pre-defined relationships between stored data. For example, stored data may be stored in tables of columns and rows. The tables may make up one or more database objects 108, 110. A database object is a data structure used to store or reference data. A database object in the context of the present disclosure may comprise one or more tables of geodata 112, 114 associated with a particular geological entity, geological test or geological experiment. The geodata 112, 114 in each database object 108, 110 may comprise data obtained from a plurality of data sources. For example, a particular example database object 108 may comprise a variety of geodata 112 relevant to a particular borehole. This borehole geodata may comprise data obtained through a variety of means and from a number of sources, represented in multiple tables, such as data obtained using a cone penetrometer test (CPT), data from lab or field-based experiments on soil samples taken from the borehole, seismology data obtained from or around the borehole, or data from any other suitable sensor or measuring device associated with the borehole in question. All this geodata for the borehole can then be grouped as one or more tables making up a database object 108 and stored within the database 104. Other database objects 110 will similarly contain tables of geodata 114 associated with different respective geological entities. Geological entities may include boreholes, groundwater wells, climate measurement stations, soil containers, water containers or any other suitable entity, geological site or test from which geological data can be obtained. Geodata 112, 114 may accordingly contain any suitable data obtainable from such geological entities, including but not limited to borehole logs, general geological site data, soil sample data, pictures of the geological entity, data sequences (such as obtained through a CPT experiment), field and laboratory measurement data, well design data, groundwater data and so on. In some examples, a project may comprise multiple database objects 108, 110. In some examples, a database object is made up of one or more tables. It is understood that a database object may be any appropriate way to store or reference any particular geological entity, geological test or geological experiment. For example, instead of a collection of one or more tables, a database object may be, for example, a stored procedure, sequence, index or view.

Also shown in FIG. 1 is a publication engine 116. The publication engine 116 is configured to implement the methods disclosed herein, in order to retrieve geodata 112, 114 from the data base system in a desired data format. The publication engine 116 and database system need not be co-located. For example, the publication engine 116 may be run on a user device and the database may be hosted on computer clusters, cloud storage or file systems on one or more different computing devices. The publication engine 116 comprises a plurality of publication methods 118 which can be configured to retrieve, output and display different types of geodata 112, 114 in different formats. The publication engine 116 is configured to retrieve geodata 112 from database objects 108 in database 104. The retrieved geodata 112 can then be displayed on a GUI or exported as an output file. Put another way, the publication engine 116 is configured, responsive to user input, to execute a particular publication method 118.

A publication method 118 may comprises a level requirement defining one or more locations within the database system at which the publication method can be executed. For example, the level requirement defines a specific database in the database system. In some examples the level requirement defines a specific object in the database system. In some examples the level requirement defines a specific project in the database system wherein a project is made up or one or more objects. In some examples, the level requirements define multiple databases, projects, objects or tables on which the publication method can be executed.

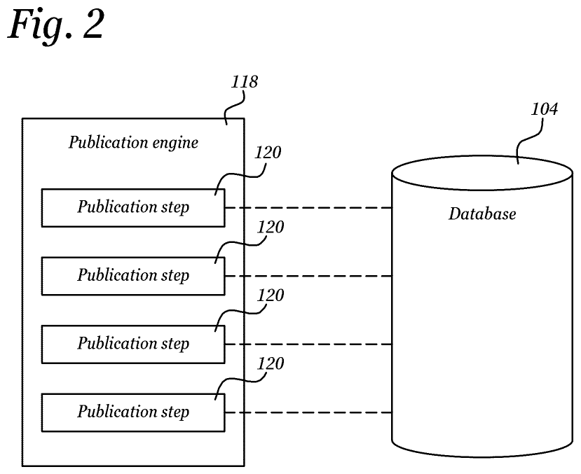

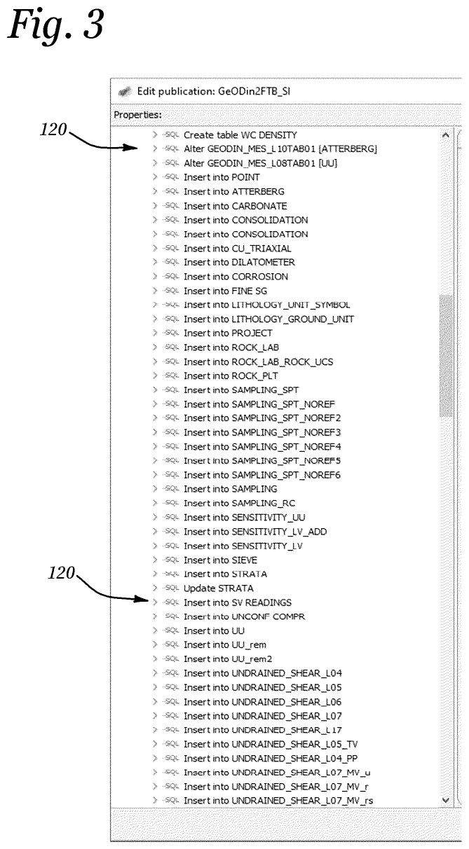

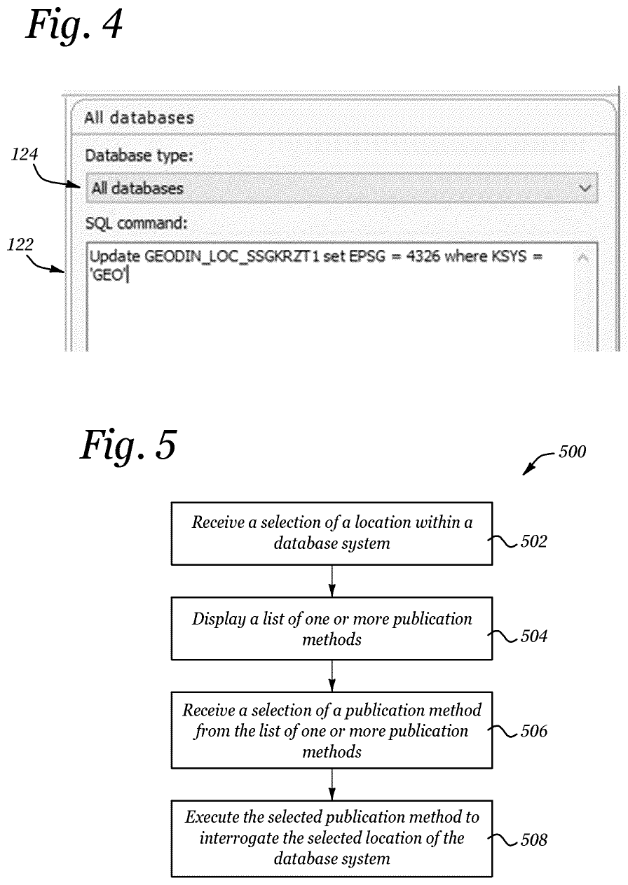

The publication method 118 further comprises a plurality of publication steps 120. A publication step 120 may define an action performed on the database system, for example, opening or closing a database connection between the publication engine 116 and the database system 102. A publication step may define an action performed on the data in the database system 102, for example, an export action, an export ground description action, an unpack data sequences action or an action performed by a SQL command. FIG. 2 shows a subset of system 100. FIG. 2 shows the publication method 118 comprising a plurality of publication steps 120. When executed, a publication method 118 executes each publication step 120 on the database 104 in a predetermined order. FIG. 3 shows further examples of publication steps 120. The publication steps shown in FIG. 3 are actions performed by one or more SQL commands, such as the SQL command 122 in FIG. 4 described below.

An action performed by a SQL command may be defined using one or more appropriate SQL commands that may be executed on the database system. In some examples, at least one of the plurality of publication steps correspond to an action performed by one or more SQL commands, wherein executing the publication method comprises executing the one or more SQL commands in a pre-defined order to perform the action corresponding to the publication step.

An action may be performed by one or more SQL commands of a generic syntax that can be executed on any database type. In such cases the at least one publication step further comprises a label specifying the one or more SQL commands are of a generic syntax, in which case the generic syntax may be used to perform the action on any database type, regardless of the location on which the publication method is run. FIG. 4 shows that the SQL command 122 is a generic SQL command by indicating a database type of “All databases” in label field 124. Alternatively, the type of database could be displayed in label field 124 for database-specific SQL commands.

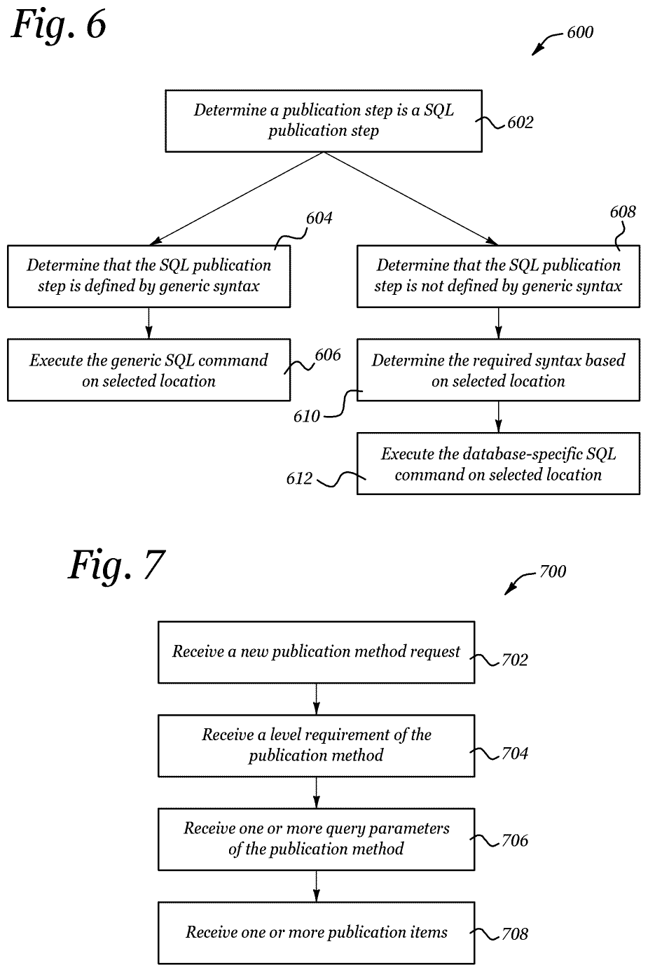

An action may be performed by one or more SQL commands of a database-specific syntax that can only be executed on a specific database type. In such cases, the action may be defined by multiple commands defining the action in multiple specific syntaxes, each comprises a label specifying which database-specific syntax they apply to. In such cases, a command of the appropriate syntax may be run to perform the action defining the publication step, based on a location in the database system in which the publication method is executed. This is described in more detail with reference to FIG. 6 below, which shows a method 600 of executing a SQL publication step of the selected publication method.

Macros may be used in the SQL commands or/and in the name of the publication steps. In the described examples t, macros may be used to pull the current project, object or measurement ID of the location selection in order to execute the publication method at the selected location. For example, appropriate macros may include:
$PRJID$ to pull the project ID
$LOCID$ to pull the object ID
$INVID$ to pull the measurement ID
   However, it should be understood that macros may be used to pull any appropriate variable, for example any variable that may be determined from the selected location.

The publication engine 116 may provide a suitable graphical user interface, GUI, configured to effectively display geodata. The GUI may also comprise a database object selection area comprising a list of database objects (e.g. database objects 108) available for selection. The GUI may be configured such that, in response to selection of a database object from the list of database objects, a list of publication methods for changing the data structure of the selected object may be displayed.

FIG. 5 shows a method 500 of retrieving data from a database system 102 using publication engine 116. The method 500 allows a user to select a location in a database system and a desired publication method to export the data selected location in a desired data format. The method is computer implemented and may be performed by the publication engine 116 described in FIG. 1.

In step 502, the publication engine 116 receives a selection of a location within a database system. The database system may be the database system 102 comprising geodata 112, 114 described in FIG. 1. The selection of a location may be received via the GUI described above. The location may be any location within the database system for example the database 104 or a group of data described by the object 108. In some examples, the location may be at a project level, wherein a project may comprise multiple objects 108 In some examples, the location may be at the geodata level 114.

In step 504, the publication engine 116 displays one or more publication methods 118. In some examples, the publication engine 116 displays only publication methods 118 with a level requirement compatible with the received selection of a location. Each publication method 118 comprises a level requirement, a plurality of publication steps 120 and optionally a description indicating the outcome of the actions performed by the publication steps 120. For example, if an object 108 is received as the selected location in step 502, the publication engine 116 may display only publication methods with a level requirement compatible with the selected object. For example, in some examples, each of the displayed publication methods correspond to a different data format (i.e. ordered by date and excluding measurements prior to a desired date) in which the data at the selected location can be outputted. As such, the displayed publication methods 118 provide different options for exporting the data at the selected location.

In step 506, the publication engine 116 receives a selection of a publication method 118 from a list of one or more publication methods 118. The selection of a location may be received via the GUI based on the description of the publication method which details the actions performed by the publication steps 120. The description may further comprise a description of the file format to which the publication method is output and a description of the structure of the output.

In step 508, the publication engine 116 may execute the selected publication method 118 to interrogate the identified location of the database system. In the present disclosure, the use of “interrogate” may refer to any action of viewing or changing a location of the database system. For example, interrogate may include inserting columns into existing tables, merging tables, changing the data type of variables, and removing rows where conditions are not met. Interrogate may further comprise making or deleting tables, for example making temporary tables comprising data from one or more tables in order to view the location of the database system. An example of actions of interrogating a database are shown by the publication steps 120 in FIG. 3, however it should be understood that any action of altering, reading, or exporting from a database may be performed at the identified location. In step 508, each of the publication steps 120 of the publication method 118 are executed in a predefined order to produce a data output wherein the data output is in a data format different to the data format to the database data at the selected location.

In some examples, at least one of the plurality of publication steps corresponds to an export action to export the output data to a pre-defined file format. For example, in some examples, the pre-defined file format may comprise one or more of: an MS Access database as an export file; an excel document; a *.csv; or a *.txt. In some examples, a publication step corresponding to an action to export the data is based on a coding standard of the required system with which the output is to be compatible.

In some examples, at least one of the plurality of publication steps corresponds to an action performed by a SQL command. As described above with reference to FIG. 1-4, publication steps corresponding to an action performed by a SQL command may be performed by a generic SQL command or a database specific SQL command, as indicated by a label 124 associated with the SQL command. The method 500 allows a user to select a location in a database system and a desired publication method to export the data at the selected location in a desired data format without requiring the use of computer programming or knowledge of database specific syntax.

FIG. 6 shows a method 600 of executing a SQL publication step of the selected publication method in the required database-specific syntax without a user providing the required syntax. The publication engine 116 is able to determine the correct syntax for the publication step using a location selection received by the publication engine and the label 124 associated with each SQL command defining an SQL publication step.

In step 602, the publication engine 118 determines that the next publication step in the publication method is a SQL publication step. Following step 602, the method 600 either comprises steps 604 and 606 or steps 608, 610 and 612. The route which method 600 takes is determined by the label 124 associated with the SQL publication step 120.

In step 604, the publication engine 118 determines that the next publication step in the publication method is a SQL publication step defined by generic syntax as label 124 indicates that the SQL can be executed on any database.

In step 606, the publication engine 118 executes the SQL command on the selected location in the database system.

Alternatively, at step 608, the publication engine 118 determines that the next publication step in the publication method is a SQL publication step defined not by generic syntax as label 124 indicates that the SQL can only be executed on a specific database.

At step 610, the publication engine 118 determines the required syntax based on the selected location. For example, the publication engine 118 may determine that the selected location is within a Microsoft Access database and requires a Microsoft Access Specific SQL Command to perform the action defined by the publication step. The publication engine selects the appropriate syntax-specific SQL command corresponding to the action defined by the publication step.

At step 612, the publication engine 118 executes the syntax specific SQL command on the selected location in the database system. In both routes described by method 600, the correct SQL command is executed without user input identifying the syntax required.

The publication methods 118 in publication engine 116 may be edited to include or removing additional publication steps. In addition, new publication methods can be created.

FIG. 7 shows a method 700 of creating a publication method. A new publication method may be constructed using a plurality of pre-defined publication steps from a library of publication steps or by defining a plurality of new publication steps.

At step 702, the publication engine 116 receives a new publication method request. The request may be received via the GUI described above with reference to FIG. 1 and may comprise a name of the new publication method. The request may further comprise text and/or a symbol to help identify the publication method.

At step 704, the publication engine 116 receives a level requirement for the new publication method. The level requirement defines one or more locations within the database system at which the publication method can be executed. A location described both a data structure and a database type, for example, an object in an Oracle Server database.

At step 706, the publication engine 116 receives one or more query parameters of the publication method.

At step 708, the publication engine 116 receives a plurality of publication steps for the new publication method. The plurality of publication steps is compatible with the level requirement of the publication method. The publication steps 120 may be one or more of:
an export action;
an export ground description action;
an unpack data sequences action;
an action performed by one or more SQL commands; and
a close database connection action,

In some examples, publication items have predefined constraints. For example, a publication item defining the closing of a database connection must be placed after the final publication item that interrogates the database. As such, new publication methods for retrieving data from a geodatabase system in a different data format can be created and edited according to method 700.

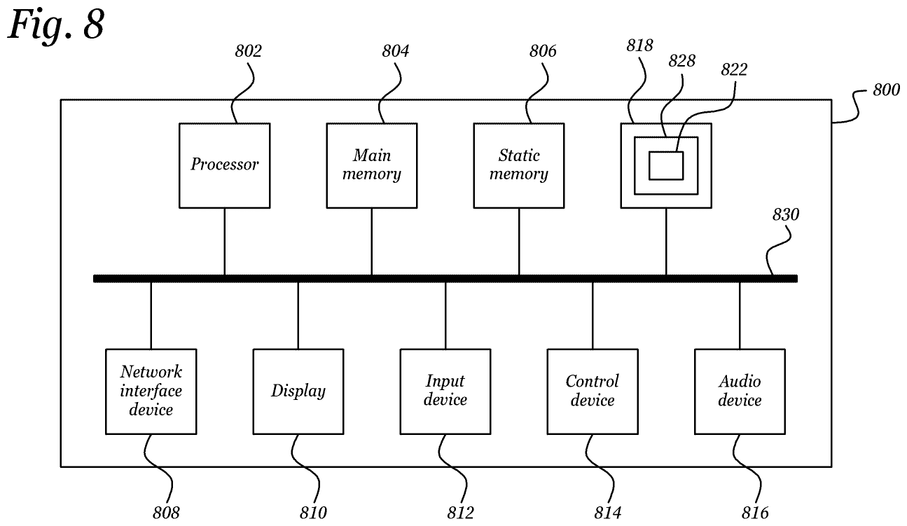

FIG. 8 shows a block diagram of one implementation of a computing device 800 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine.

Further, while only a single computing device is illustrated, the term “computing device” shall also be taken to include any collection of machines (e.g., computers) that individually or jointly execute a set (or multiple sets) of instructions to perform any one or more of the methodologies discussed herein. More particularly, a number of computing devices can be used to compute cross-correlations of signal data subsets independently and in parallel, as described above. Each computing device may have the structure shown in FIG. 8. Alternatively, a plurality of processors within a single computing device, such as computing device 800, can perform the independent computations.

The example computing device 800 includes a processor 802, a main memory 804 (e.g., read-only memory (ROM), flash memory, dynamic random-access memory (DRAM) such as synchronous DRAM (SDRAM) or Rambus DRAM (RDRAM), etc.), a static memory 806 (e.g., flash memory, static random access memory (SRAM), etc.), and a secondary memory (e.g., a data storage device 818), which communicate with each other via a bus 830.

Processor 802 represents one or more general-purpose processors such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 802 may also be one or more special-purpose processors such as an application specific integrated circuit (ASIC), a field programmable gate array (FPGA), a digital signal processor (DSP), network processor, or the like. Processor 802 is configured to execute the processing logic (instructions 822) for performing the operations and steps discussed herein.

The computing device 800 may further include a network interface device 808. The computing device 800 also may include a video display unit 810 (e.g., a liquid crystal display (LCD) or a cathode ray tube (CRT)), an alphanumeric input device 812 (e.g., a keyboard or touchscreen), a cursor control device 814 (e.g., a mouse or touchscreen), and an audio device 816 (e.g., a speaker).

It will be apparent that some features of computer device 800 shown in FIG. 8 may be absent. For example, one or more computing devices 800 may have no need for display device 810 (or any associated adapters). This may be the case, for example, for particular server-side computer apparatuses 800 which are used only for their processing capabilities and do not need to display information to users. Similarly, user input device 812 may not be required. In its simplest form, computing device 800 comprises processor 802 and memory 804.

The data storage device 818 may include one or more machine-readable storage media (or more specifically one or more non-transitory computer-readable storage media) 828 on which is stored one or more sets of instructions 822 embodying any one or more of the methodologies or functions described herein. The instructions 822 may also reside, completely or at least partially, within the main memory 804 and/or within the processor 802 during execution thereof by the computer system 800, the main memory 804 and the processor 802 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “identifying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method of retrieving data from a database system, the method comprising:
receiving, a selection of a location within a database system, wherein the database system comprises one or more databases, wherein data at the selected location within the database system is of a first data format;
displaying, a list of one or more publication methods;
receiving, a selection of a publication method from the list of one or more publication methods, wherein the selected publication method corresponds to the selected location of the database system; and
executing, the selected publication method to interrogate the selected location of the database system, wherein executing the selected publication method produces a data output, wherein the data output comprises data in a second data format different to the first data format.

2. The method of claim 1, wherein the selected publication method comprises:
a level requirement defining one or more locations within the database system at which the publication method can be executed;
a plurality of publication steps, wherein each publication step of the plurality of publication steps corresponds to an action performed on the database system or an action performed on the data in the database system, wherein executing the publication method comprises executing the plurality of publication steps in a pre-defined order; and
a description indicating an outcome of the actions performed by the plurality of publication steps.

3. The method of claim 2, wherein only the one or more publication methods comprising a respective level requirement compatible with the received selection of the location are displayed.

4. The method of claim 2, wherein a publication step of the plurality of publications steps may be one of:
an export action;
an export ground description action;
an unpack data sequences action;
the action performed by one or more SQL commands; and
a close database connection action.

5. The method of claim 2, wherein at least one of the plurality of publication steps correspond to the action performed by one or more SQL commands, wherein executing the publication method comprises executing the one or more SQL commands in the pre-defined order to perform the corresponding action.

6. The method of claim 2, wherein the action is performed by one or more SQL commands of a generic syntax that can be executed on any database type and wherein at least one publication step further comprises a label specifying the one or more SQL commands are of the generic syntax.

7. The method of claim 2, wherein the action is performed by one or more SQL commands of a database-specific syntax that can only be executed on a first specific database type, and wherein at least one publication step further comprises a label specifying the one or more SQL commands are of a first database-specific syntax.

8. The method of claim 7, wherein the action is performed by one or more further SQL commands of a database-specific syntax that can only be executed on a second specific database type, wherein the at least one publication step further comprises a label specifying the one or more further SQL commands are of a second database-specific syntax different from the first database-specific syntax.

9. The method of claim 7, or further comprising determining the database-specific syntax based on the selection of the location.

10. The method of claim 5, wherein the one or more SQL commands comprise a macro.

11. The method of claim 2, wherein at least one of the plurality of publication steps corresponds to an export action to export output data to a pre-defined file format, optionally, wherein the pre-defined file format comprises one or more of a MS Access database export file, a *.ales file, *.txt file or a *.csv file.

12. The method of claim 2, wherein a publication step of an export action defines a coding standard.

13. The method of claim 1, wherein interrogating the database system comprises one or more of viewing, altering or exporting from the database system.

14. The method of claim 1, wherein the database system comprises one or more relational databases.

15. A system comprising:
one or more processors; and
one or more memories having stored thereon computer-readable instructions which when executed by the one or more processors, cause the one or more processors to:
receive a selection of a location within a database system, wherein the database system comprises one or more databases, wherein data at the selected location within the database system is of a first data format;
display a list of one or more publication methods;
receive a selection of a publication method from the list of one or more publication methods, wherein the selected publication method corresponds to the selected location of the database system; and
execute the selected publication method to interrogate the selected location of the database system, wherein executing the selected publication method produces a data output, wherein the data output comprises data in a second data format different to the first data format.

16. The system of claim 15, wherein the selected publication method comprises:
a level requirement defining one or more locations within the database system at which the publication method can be executed;
a plurality of publication steps, wherein each publication step of the plurality of publication steps corresponds to an action performed on the database system or an action performed on the data in the database system, wherein executing the publication method comprises executing the plurality of publication steps in a pre-defined order; and
a description indicating an outcome of the actions performed by the plurality of publication steps.

17. The system of claim 16, wherein only the one or more publication methods comprising a respective level requirement compatible with the received selection of the location are displayed.

18. The system of claim 16, wherein a publication step of the plurality of publications steps may be one of:
an export action;
an export ground description action;
an unpack data sequences action;
the action performed by one or more SQL commands; and
a close database connection action.

19. The system of claim 16, wherein at least one of the plurality of publication steps correspond to the action performed by one or more SQL commands, wherein executing the publication method comprises executing the one or more SQL commands in the pre-defined order to perform the corresponding action.

20. The system of claim 16, wherein the action is performed by one or more SQL commands of a generic syntax that can be executed on any database type and wherein at least one publication step further comprises a label specifying the one or more SQL commands are of the generic syntax.
